(19) United States
(12) Patent Application Publication
(10) Pub. No.: US 2004/0194209 A1
(43) Pub. Date: Oct. 7, 2004

(54) Piston compressor

(76) Inventors: Masaki Ota, Kariya-shi (JP); Tomoji Tarutani, Kariya-shi (JP); Yoshinori Inoue, Kariya-shi (JP); Hisato Kawamura, Kariya-shi (JP); Kenji Mochizuki, Kariya-shi (JP); Shigeki Kawachi, Kariya-shi (JP); Junichi Takahata, Kariya-shi (JP); Masahiro Kawaguchi, Kariya-shi (JP)

Correspondence Address: MORGAN & FINNEGAN, L.L.P., 345 Park Avenue, New York, NY, 10154, US

(21) Appl. No.: 10/778,952

(22) Filed: Feb. 13, 2004

(30) Foreign Application Priority Data
Feb. 17, 2003 (JP) 2003-038704

(51) Int. Cl. A61G 7/10

(52) U.S. Cl. 5/81.1 R; 5/53.1

(57) ABSTRACT

A rotary valve operationally connected to a rotary shaft is housed so as to be slidably rotatable in an accommodation hole formed in a cylinder block. A suction valve mechanism functions so as to introduce refrigerant gas in a suction chamber into a compression chamber. A gas suction passage leading from the suction chamber to the compression chamber can be opened and closed in synchronism with rotation of the rotary shaft. In an outer circumferential surface of the rotary valve is formed a groove constituting a part of a gas vent passage for introducing the refrigerant gas in a crank chamber into the compression chamber.

### BACKGROUND OF THE INVENTION

The present invention relates to a piston compressor.

For example, a piston compressor disclosed in Japanese Laid-Open Patent Publication No. 5-231309 has a rotary valve for sucking refrigerant, which is housed in an accommodation hole formed in a cylinder block to be slidably rotatable. The rotary valve is operationally connected to a rotary shaft to which power from a drive source is given. The cylinder block is provided with a downstream suction passage communicating with the accommodation hole and compression chambers. The rotary valve is provided with an upstream suction passage that enables a suction chamber and the downstream suction passage to communicate with each other in synchronism with reciprocating motion of pistons. Also, the rotary valve is formed with a communication path that connects the upstream suction passage to a crank chamber via a shaft passage provided in the rotary shaft.

The synchronous rotation of the rotary valve and the rotary shaft allows the crank chamber to be consecutively connected with the compression chambers in synchronism with the reciprocating motion of the pistons via the shaft passage, the communication path, and both of the suction passages. Thereby, for example, lubricating oil is supplied from the crank chamber to the compression chambers.

In this construction, a variable displacement mechanism is provided. The variable displacement mechanism varies the stroke of the pistons by controlling the pressure in the crank chamber based on the balance control between refrigerant gas inflow rate from a discharge chamber to the crank chamber and refrigerant gas outflow rate from the crank chamber to the outside thereof. In this pressure control, the aforementioned communication path functions as a gas vent passage for introducing the refrigerant gas in the crank chamber into the upstream suction passage via the shaft passage.

In the above-described construction, since inflow of refrigerant gas from the discharge chamber to the crank chamber leads to a decrease in refrigerant gas to be discharged to the outside of the compressor, a smaller inflow rate is desirable. In order to improve the controllability in the pressure control by permitting the pressure in the crank chamber to be raised with high response in a state in which the refrigerant gas inflow rate to the crank chamber is small, it is effective to decrease the refrigerant gas outflow rate from the crank chamber to the outside thereof, for example, by providing a restriction in the passage for gas venting. In the construction described in Japanese Laid-Open Patent Publication No. 5-231309, a small-diameter portion that functions as affixed restriction capable of restraining the flow rate of refrigerant gas in the communication path is provided in a midway portion of the communication path.

As the piston compressor, besides the above-described construction in which the rotary valve is slidably rotatable in the accommodation hole in the cylinder block, a construction is generally known in which, for example, no rotary valve for sucking refrigerant is provided, and one end of the rotary shaft is accommodated in the accommodation hole and is slidably supported by the inner circumferential surface of the accommodation hole.

However, the communication path in the construction described in Japanese Laid-Open Patent Publication No. 5-231309 consists of a hole formed so as to penetrate the rotary valve, so that to form the communication path, work such as drilling is needed. Also, since a small-diameter portion for functioning as a fixed restriction is provided in this communication path, it is necessary to form this small-diameter portion by using a small-diameter drill, which is liable to have insufficient strength and hence to chatter or be broken. Therefore, it is an especially troublesome job to machine this portion with high accuracy.

Also, in order to rotate the rotary valve and the rotary shaft in the accommodation hole without shakiness, it is desirable to set a gap between the inner circumferential surface of the accommodation hole and the rotary valve and the outer circumferential surface of the rotary shaft as small as possible. In this case, however, both of the circumferential surfaces are not lubricated well.

### SUMMARY OF THE INVENTION

An objective of the present invention is to provide a piston compressor in which a gas vent passage leading from a crank chamber can be formed easily and accurately, and lubrication between an accommodation hole and a rotary valve for sucking refrigerant and a rotary shaft that are housed in the accommodation hole can be performed well.

To achieve the foregoing and other objectives and in accordance with the purpose of the present invention, a piston type compressor that compresses refrigerant drawn to a compression chamber from a suction chamber, and discharges the refrigerant to a discharge chamber is provided. The compressor includes a rank chamber, a rotary shaft, a cylinder block-having a cylinder bore and an accommodation hole, a piston housed in the cylinder bore, a driving member accommodated in the crank chamber, a cylindrical rotary valve;

a piston housed in the cylinder bore, wherein the piston defines the compression chamber in the cylinder bore;

a driving member accommodated in the crank chamber, wherein the driving member is coupled to the piston to convert rotation of the rotary shaft to reciprocation of the piston, and a gas vent passage for sending refrigerant gas from the crank chamber to the compression chamber. The cylindrical rotary valve is coupled to the rotary shaft and rotatably accommodated in the accommodation hole. An outer circumferential surface of the rotary valve slides along an inner circumferential surface of the accommodation hole. In accordance with rotation of the rotary shaft, the rotary valve selectively opens and closes a gas suction passage between the suction chamber and the compression chamber. At least a part of the gas vent passage is formed by a groove that is located in at least one of the inner circumferential surface of the accommodation hole and the outer circumferential surface of the rotary valve.

The present invention provides another piston type compressor that compresses refrigerant drawn to a compression chamber from a suction chamber, and discharges the refrigerant to a discharge chamber. The compressor includes a crank chamber, a cylinder block having a cylinder bore and an accommodation hole, a rotary shaft, piston housed in the cylinder bore, and a driving member accommodated in the crank chamber, a gas vent passage for sending refrigerant gas from the crank chamber to the compression chamber. One end of the rotary shaft is supported by an inner circumferential surface of the accommodation hole such that the one end is rotatably received by the accommodation hole. The piston defines the compression chamber in the cylinder bore. The driving member is coupled to the piston to convert rotation of the rotary shaft to reciprocation of the piston. At least a part of the gas vent passage is formed by a groove that is located in at least one of the inner circumferential surface of the accommodation hole and an outer circumferential surface of the rotary shaft.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view illustrating a piston compressor in accordance with one embodiment of the present invention;

FIG. 2 is a 6ross-sectional view taken along line 1-1 of FIG. 1;

FIG. 3 is a developed view of an outer circumferential surface of a rotary valve;

FIG. 4 is a developed view of an outer circumferential surface of a rotary valve of a modified embodiment;

FIG. 5 is a developed view of an outer circumferential surface of a rotary valve of still another modified embodiment;

FIG. 6 is a partially cross-sectional view of a piston compressor of another modified embodiment; and

FIG. 7 is a partially cross-sectional view of a piston compressor of still another modified embodiment.

### DETAILED DESCRIPTION OF THE PREFERRED EMBODIMENTS

A variable displacement piston compressor in accordance with the present invention, which is used for a vehicular air conditioning system, will now be described.

First, the variable displacement piston compressor will be explained.

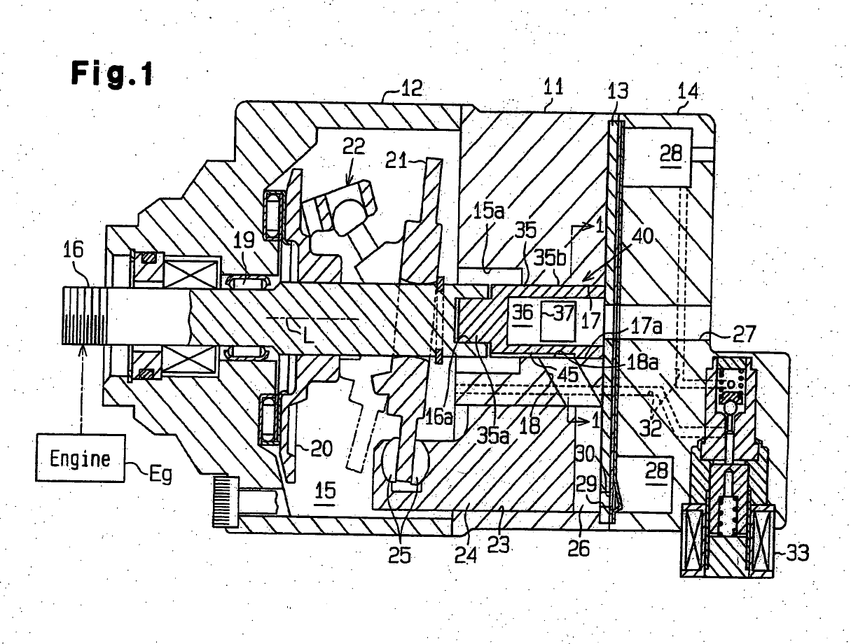

As shown in FIG. 1, the compressor includes a cylinder block 11, a front housing member 12 fixed to a front end of the cylinder block 11, and a rear housing member 14 fixed to a rear end of the cylinder block 11 via a valve plate assembly 13. The cylinder block 11, the front housing member 12, and the rear housing member 14 constitute a housing for the compressor. In FIG. 1, a left-hand side of the drawing indicates the front, and the right-hand side thereof the rear

In the region surrounded by the cylinder block 11 and the front housing member 12, a crank chamber 15 is defined. A rotary shaft 16 is disposed so as to extend through the crank chamber 15, and is rotatably supported between the front housing member 12 and the cylinder block 11. The rotary shaft 16 is operationally connected to an engine Eg, which is a drive source for running the vehicle, and is rotated by power supplied from the engine Eg. A front side of the rotary shaft 16 is supported by the front housing member 12 via a roller bearing 19.

In the crank chamber 15, a lug plate 20 is fixed to the rotary shaft 16 so as to be integrally rotatable. The crank chamber 15 contains a swash plate 21 serving as a cam body. The swash plate 21 is supported on the rotary shaft 16 so as to be slidable and tiltable. A hinge mechanism 22 is interposed between the lug plate 20 and the swash plate 21. Therefore, the swash plate 21 can be rotated in synchronism with the lug plate 20 and the rotary shaft 16 by hinge connection between the swash plate 21 and the lug plate 20 via the hinge mechanism 22 and the support of the rotary shaft 16. Also, the swash plate 21 can be tilted with respect to the rotary shaft 16 while sliding in the direction of axis L of the rotary shaft 16.

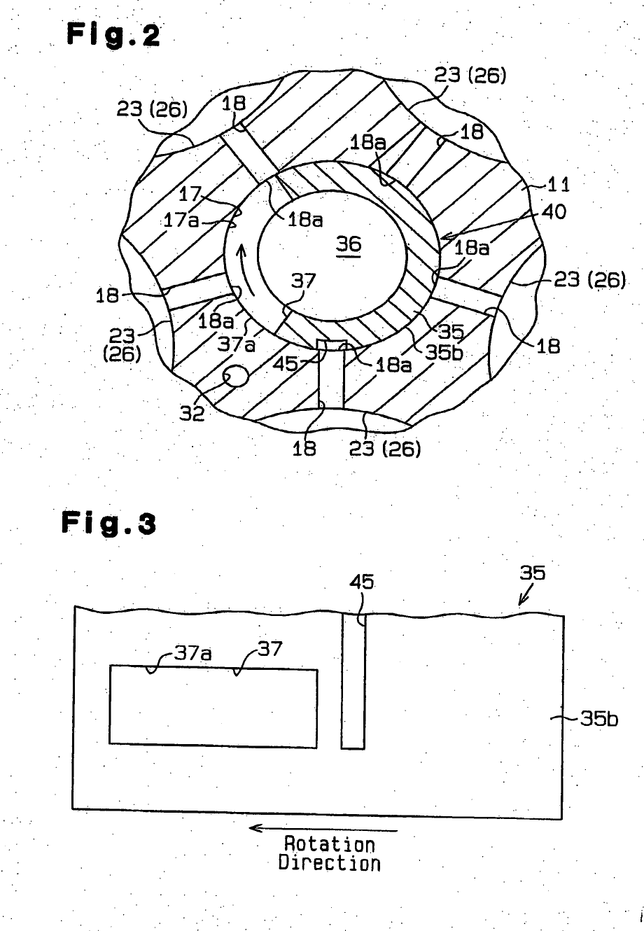

As shown in FIGS. 1 and 2, a plurality of cylinder bores 23 are penetratingly formed in the cylinder block 11 so as to surround a rear end of the rotary shaft 16. A single-headed piston 24 is housed in each of the cylinder bores 23 so as to be capable of reciprocating. The front and rear openings of the cylinder bore 23 are closed by the piston 24 and the valve plate assembly 13 respectively. A compression chamber 26 whose volume changes according to the reciprocating motion of the piston 24 is defined in each cylinder bore 23.

Each piston 24 is engaged with the outer periphery of the swash plate 21 via shoes 25. Therefore, the rotation of the swash plate 21 caused by the rotation of the rotary shaft 16 is converted to the reciprocating motion of the pistons 24 via the shoes 25.

As shown in FIG. 1, a communication path 27 extends through the valve plate assembly 13 and the rear housing member 14. Also, the rear housing member 14 is formed with a discharge chamber 28. The communication path 27 is formed in the central portions of the valve plate assembly 13 and the rear housing member 14. The discharge chamber 28 is formed so as to surround the outer periphery of the communication path 27. The communication path 27 is connected with a pipe (not shown) connected to a heat exchanger of an external refrigerant circuit that is located in the passenger compartment. The discharge chamber 28 is connected with a pipe (not shown) connected to a heat exchanger of the external refrigerant circuit, that is located outside of the passenger compartment. The external refrigerant circuit and the compressor constitute a refrigerant circuit.

The refrigerant gas in the communication path 27 is sucked into each compression chamber 26 via a suction valve mechanism 40 disposed in the cylinder block 11 by the movement of corresponding pistons 24 from the top dead center position to the bottom dead center position (suction stroke). The refrigerant gas sucked into the compression chamber 26 is compressed to a predetermined pressure by the movement of the piston 24 from the bottom dead center position to the top dead center position (compression stroke), and is discharged into the discharge chamber 28 via a discharge port 29 and a discharge valve 30 formed in the valve plate assembly 13 (discharge stroke). The refrigerant gas discharged into the discharge chamber 28 is exhausted to the external refrigerant circuit.

Next, the suction valve mechanism,40 will be explained.

As shown in FIGS. 1 and 2, in the housing of the compressor, an accommodation hole 17 is formed in a central portion surrounded by the cylinder bores 23 in the cylinder block 11. The accommodation hole 17 has a cylindrical internal space extending in the direction of an axis L, and communicates with the communication path 27 on the rear side. The accommodation hole 17 and the compression chamber 26 communicate with each other via a plurality of gas inlet passages (downstream suction passage) 18 formed in the cylinder block 11.

In the accommodation hole 17, a cylindrical rotary valve 35 for sucking refrigerant is accommodated so as to be slidably rotatable. An inner circumferential surface 17a of the accommodation hole 17 and an outer circumferential surface 35b of the rotary valve 35 each constitute a seal surface for, providing a seal between the accommodation hole 17 and the rotary valve 35.

In the rotary valve 35, a rear end of the internal space thereof is open to the communication path 27, and a small-diameter portion 35a is provided in a front end portion thereof. In a rear end face of the rotary shaft 16, which faces the accommodation hole 17, an attachment hole 16a is provided. In the attachment hole 16a of the rotary-shaft 16, the small-diameter portion 35a of the rotary valve 35 is pressed in and fixed. Therefore, the rotary shaft 16 and the rotary valve 35 are integrated on the same axis L, and hence the rotary valve 35 is rotated in synchronism with the rotation of the rotary shaft 16, that is, the reciprocating motion of the piston 24. Also, a rear end of the rotary shaft 16 is slidably supported by the inner circumferential surface 17a of the accommodation hole 17 via the rotary valve 35.

The internal space of the rotary valve 35 forms a suction chamber 36 communicating with the communication path 27 As shown in FIGS. 2 and 3, a gas guide hole (upstream suction passage) 37 is formed in the circumferential wall of the rotary valve 35. An end portion of the gas guide hole 37 on the internal space side of, the rotary valve 35 always communicates with the suction chamber 36. Also, an end portion of the gas guide hole 37 on the outside of the rotary valve 35 is open in a circumferential direction on the outer circumferential surface 335b of the rotary valve 35. FIG. 3 shows a state in which the outer circumferential surface 35b of the rotary valve 35 is developed. The transverse direction of FIG. 3 corresponds to the circumferential direction, that is, relational direction of the rotary valve 35, and the upside of the figure corresponds to the front of the compressor. The gas guide hole (upstream suction passage) 37 and the gas inlet passage (downstream suction passage) 18 constitute a gas suction passage leading from the suction chamber 36 to the compression chamber 26. The rotary valve 35 intermittently allows the gas guide hole 37 to communicate with the gas inlet passage 18 by means of the rotation thereof. That is to say, the rotary valve 35 can open and close the gas suction passage in synchronism with the rotation of the rotary shaft 16.

Specifically, when each piston 24 takes the suction stroke, the rotary valve 35 allows the gas guide hole 37 to communicate with the gas inlet passage 18 in the cylinder block 11 Therefore, the refrigerant gas in the suction chamber 36 is sucked into the compression chamber 26 corresponding to the piston 24 through the gas guide hole 37 and the gas inlet passage 18. When the suction stroke of the piston 24 finishes, the gas guide hole 37 shifts completely in a circumferential direction with respect to the gas inlet passage 18 so that the suction of refrigerant gas into the compression chamber 26 is stopped. That is, the gas inlet passage 18 becomes closed state. When the piston, 24 takes the discharge stroke, the closed state of the gas inlet passage 18 is kept by the outer circumferential surface 35b of the rotary valve 35 so that the compression of refrigerant gas and the discharge thereof to the discharge chamber 28 are not hindered

Next, a gas vent passage will be explained.

As shown in FIGS 1 to 3, in the outer circumferential surface 35b of the rotary valve 35, a groove 45 extending in the direction of the axis L is formed at a position shifled in a circumferential direction from an opening 37a on the outer circumferential surface side of the gas guide hole 37. A front end of the groove 45 is disposed in a central chamber 15a constituting a rear region of the crank chamber 15, which is provided in front of the accommodation hole 17 in the cylinder block 11. The groove 45 extends rearward to a position at which a rear end thereof can face an opening 18a on the accommodation hole 17 side of the gas inlet passage 18. Specifically, an in-groove region of the groove 45, which is surrounded by the groove 45 and the inner circumferential surface 17a of the accommodation hole 17, functions as a communication path for successively allowing the crank chamber 15 and each of the gas inlet passages 18 to communicate with each other in synchronism with the rotation of the rotary valve 35 in a state in which the rotary valve 35 is rotated by the rotation of the rotary shaft 16.

The groove 45 is arranged at a position corresponding to the gas inlet passage 18 for the compression chamber 26 that has a low pressure (equivalent to the suction pressure) immediately after the suction stroke finishes (that is, at the compression start time). That is to say, the groove 45 is provided at a position near the opening 37aof the gas guide hole 37 on the opposite side to the direction of rotation (indicated by an arrow in FIGS. 2 and 3) of the rotary valve 35.

The pressure in the crank chamber 15 is higher than the pressure in the communication path 27 and the suction chamber 36 (suction pressure) be cause of the leakage of high-pressure refrigerant gas from the compression chambers 26 via a gap between the cylinder bores 23 and the pistons 24 and the introduction of high-pressure refrigerant gas from the discharge chamber 28 through a supply passage 32, described later.

Therefore, when the groove 45 faces the opening 18a of the gas inlet passage 48 due to the rotation of the rotary shaft 16, the refrigerant gas (and mist-form lubricating oil mixing with the refrigerant gas) in the crank chamber 15 is introduced into the compression chamber 26 in which compression starts via a communication path formed by the groove 45 and the gas inlet passage 18. The communication path allows the refrigerant gas to be introduced successively into each of the compression chambers 26 in synchronism with the rotation of the rotary shaft 16.

In this embodiment, the in-groove region, which is surrounded by the groove 45 and the inner circumferential surface 17a of the accommodation hole 17, and the gas inlet passage 18 constitutes a gas vent passage for introducing the refrigerant gas in the crank chamber 15 into the compression chambers 26.

In the housing of the compressor, the gas supply passage 32 and a control valve 33 are provided. The gas supply passage 32 connects the discharge chamber 28 to the crank chamber 15. At a midway position of the gas supply passage 32, the control valve 33 consisting of a solenoid operated valve is disposed.

By controlling the opening of the control valve 33, the balance between the inflow rate of high-pressure refrigerant gas to the crank chamber 15 through the gas supply passage 32 and the gas outflow rate from the crank chamber 15 through the gas vent passage is controlled, by which the internal pressure of the crank chamber 15 is controlled. A difference between the internal pressure of the crank chamber 15 and the internal pressure of the compression chambers 26 via the pistons 24 is changed according to a change of internal pressure of the crank chamber 15, and the tilt angle of the swash plate 21 is changed. As a result, the stroke of the piston 24, that is, the displacement of compressor is regulated.

For example, when the internal pressure of the crank chamber 15 is decreased, the tilt angle of the swash plate 21 increases, and the stroke of the pistons 24 increases, by which the displacement of compressor is increased. Inversely, when the internal pressure of the crank chamber 15 is increased, the tilt angle of the swash plate 21 decreases, and the stroke of the pistons 24 decreases, by which the displacement of compressor is decreased.

The rotary shaft 16, the lug plate 20, the swash plate 21, the hinge mechanism 22, the piston 24, the shoe 25, the gas supply passage 32, the control valve 33, and the gas vent passage constitute a variable displacement mechanism.

This embodiment has the following advantages.

(1) A part (the in-groove region surrounded by the groove 45 and the inner circumferential surface 17a of the accommodation hole 17) of the gas vent passage for introducing the refrigerant gas in the crank chamber 15 into the compression chamber 26 is formed by the groove 45 provided, in the outer circumferential surface 35b of the rotary valve 35. In the manufacturing process, a tool cut depth with respect to the outer circumferential surface 35b of the rotary valve 35 is controlled when the groove 45 is formed by cutting, by which passage cross-sectional area of the in-groove region (that is, the passage cross-sectional area of the gas vent passage) can be regulated. Therefore, even when the passage cross-sectional area is set small, the groove 45 has only to be formed so as to be shallow. Therefore, there is no need for using a small tool which is liable to have insufficient strength and hence to chatter or be broken.

Thereupon, unlike a mode in which the gas vent passage is formed, for example, by holes penetratingly formed in the rotary valve 35, the rotary shaft 16, the cylinder block 11, or the like, the gas vent passage can be machined easily and accurately without troublesome work such as drilling.

Also, a part (in-groove region of the groove 45) of the gas vent passage is formed between the inner circumferential surface 17a of the accommodation hole 17, which slidably supports the rotary valve 35, and the outer circumferential surface 35b of the rotary valve 35. Therefore, lubrication between the inner circumferential surface 17a and the outer circumferential surface 35b can be performed well by lubricating oil entering the gas vent passage.

(2) The in-groove region (communication path) of the groove 45 allows the crank chamber 15 and the gas inlet passage 18 to communicate with each other in synchronism with the rotation of the rotary valve 35, that is, the reciprocating motion of the pistons 24. In this embodiment, the crank chamber 15 and the gas inlet passage 18 corresponding to the compression chamber 26 having a lower pressure than the pressure of the crank chamber 15 are allowed to communicate with each other by the communication path. Therefore, the refrigerant gas in the crank chamber 15 can surely be introduced into the compression chamber 26.

Also, since the communication path allows the crank chamber 15 and the gas inlet passage 18 to communicate with each other without the use of the suction chamber 36, the refrigerant gas in the crank chamber 15 can be introduced further into the compression chamber 26, for example, in which the suction stroke has finished. According to this configuration, the refrigerant gas to be compressed can be introduced into the compression chamber 26 in larger quantity, so that the volume efficiency can be improved.

(3) The gas inlet passage 18 doubles as the passage (the gas inlet passage 18) for introducing the refrigerant gas in the crank chamber 15 into the compression chamber 26 via the in-groove region (communication path) of the groove 45 and the downstream suction passage constituting a part of the gas suction passage leading from the suction chamber 36 to the compression chamber 26. Therefore, the efficiency of space for providing both of the two passages in the cylinder block is improved.

(4) The groove 45 in the rotary valve 35 is provided at a position capable of communicating with the gas inlet passage 18 in the outer circumferential surface 35b in a state of shifting in a circumferential direction from the opening 37a of the gas guide hole 37. According to this configuration, which is different from unlike the configuration described in the publication in the prior art section in which the refrigerant gas in the crank chamber is introduced into the upstream suction passage, the refrigerant gas in the crank chamber 15 can be introduced easily into the compression chamber 26 at desired timing other than the suction stroke (in this embodiment, at the time of compression start).

(5) The in-groove region (communication path) of the groove 45 allows the crank chamber 15 to communicate with the gas inlet passage 18 corresponding to the compression chamber 26 at the time of compression start, which has a lower pressure than the pressure in the crank chamber 15. According to this configuration, at the time of compression start, the refrigerant gas sent from the crank chamber 15 is further introduced into the compression chamber 26 in which the suction stroke has finished, so that refrigerant gas to be compressed is taken into the compression chamber in larger quantity. Therefore, the volume efficiency can be improved.

(6) The compressor of this embodiment has the variable displacement mechanism which can change the stroke of the piston 24 by the pressure control of the crank chamber 15 based on the control of the balance between refrigerant gas inflow rate from the discharge chamber 28 to the crank chamber 15 and refrigerant gas outflow rate from the crank chamber 15 to the outside thereof. In this configuration, the aforementioned gas vent passage is used as a passage for introducing the refrigerant gas in the crank chamber 15 to the outside of the crank chamber 15 in the pressure control of the crank chamber 15. Therefore, for example, even in a case where the passage cross-sectional area must be set small to restrain the flow rate of refrigerant gas in this passage, this passage can be machined easily and accurately because a part of this passage is formed by the groove 45 in the rotary valve 35.

It should be apparent to those skilled in the art that the present invention may be embodied in many other specific forms without departing from the spirit or scope of the invention. Particularly, it should be understood that the invention may be embodied in the following forms.

In the above-described embodiment, the rotary valve 35 may be formed integrally with the rotary shaft 16.

In the above-described embodiment, the rear end of the rotary shaft 16 is slidably supported by the inner circumferential surface 17a of the accommodation hole 17 via the rotary valve 35. However, the present invention is not limited to this configuration. For example, the rotary shaft 16 may be supported directly by a bearing provided in the central chamber 15a of the crank chamber 15. In this case, in place of the operational connection between the rotary valve 35 and the rotary shaft 16 made by press-in fixing, it is desirable to operationally connect the rotary valve 35 to the rotary shaft 16 so that a shift between the rotation center axis of the rotary valve 35 and that of the rotary shaft 16 in the accommodation hole 17 can be allowed.

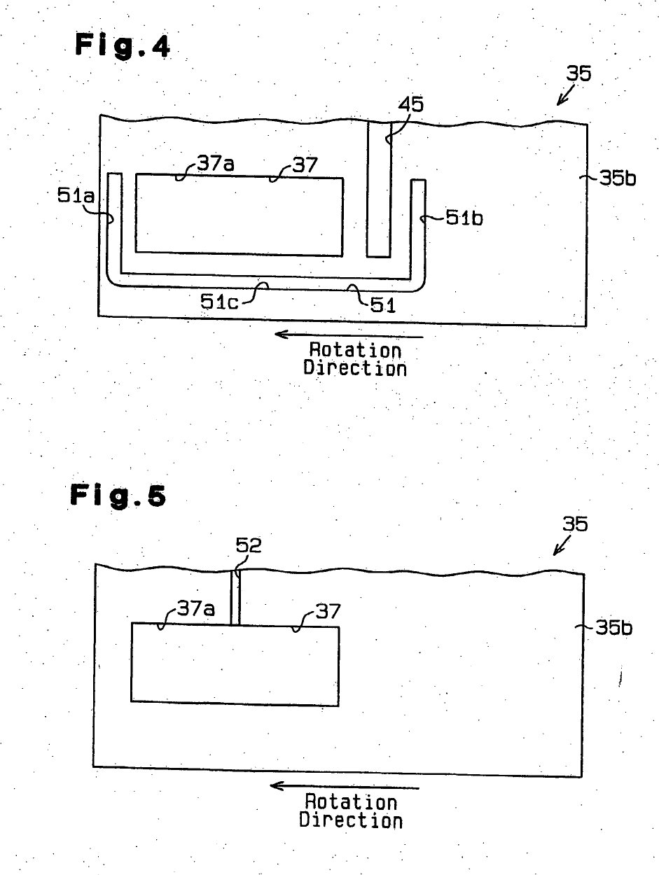

For example, as shown in FIG. 4, a residual gas bypassing groove 51 for forming a path for introducing the refrigerant gas (residual gas) from the compression chamber 26 (high pressure compression chamber) which is just after the finish of discharge stroke and before the start of suction stroke into the compression chamber 26 (low pressure compression chamber) which has a lower pressure than the pressure in the said compression chamber 26 (for example, which is just after the start of compression) may be provided in the outer circumferential surface 35b of the rotary valve 35.

The residual gas bypassing groove 51 includes an upstream-side groove 51a capable of facing the opening 18a of the gas inlet passage 18 corresponding to the compression chamber 26 that is just after the finish of discharge stroke and before the start of suction stroke, a downstream-side groove 51b capable of facing the opening 18a of the gas inlet passage 18 corresponding to the compression chamber 26 that is just after the start of compression, and an intermediary groove 51c that connects both of the grooves 51a and 51b to each other. The upstream-side groove 51a is provided at a position near the opening 37a of the gas guide hole 37 on the side of the direction of rotation (indicated by an arrow in FIG. 4) of the rotary valve 35. The downstream-side groove 51b is provided at a position near the groove 45 on the opposite side to the direction of rotation.

According to this con figuration, the residual gas in the compression chamber 26 at the time of suction stroke start decreases because high-pressure residual gas in the compression chamber 26 which is just after the finish of discharge stroke introduces into the compression chamber 26 having a low pressure which is just after the start of compression. Therefore, the re-expansion of residual gas in the compression chamber 26 on the suction stroke decreases, so that the refrigerant gas in the suction chamber 36 is sucked into the compression chamber 26 efficiently, which improves the volume efficiency.

The refrigerant gas in the crank chamber is may be introduced into the compression chamber 26 via the suction chamber 36. In this case, for example, as shown in FIG. 5, in place of the groove 45 in the above-described embodiment, a groove 52 forming a communication path for connecting the crank chamber 15 (central chamber 15a) and the gas guide hole 37 to each other is provided in the outer circumferential surface 35b of the rotary valve 35. According to this configuration, the refrigerant gas introduced from the crank chamber 15 into the gas guide hole 37 via the in-groove region of the groove 52 is sucked into an compression chamber 26 via the gas inlet passage 18 by the movement of the piston 24 from a top dead center position to a bottom dead center position in a state of being joined with the refrigerant gas from the suction chamber 36. In this case, the in-groove region of the groove 52, the suction chamber 36, and the gas guide hole 37 constitute a communication path for connecting the crank chamber 15 and the gas inlet passage 18 to each other.

Also, in such a configuration in which refrigerant gas is introduced from the crank chamber 15 into the compression chamber 26 via the suction chamber 36, for example, a hole for connecting the suction chamber 36, which is an internal space of the rotary valve 35, to the outside of the rotary valve 35 may be provided so that the refrigerant gas in the crank chamber 15 is introduced into the suction chamber 36 via this hole. In this case, for example, in the configuration shown in FIG. 5, the groove 52 is shortened (changed) so that the crank chamber 15 and an intermediate position between the crank chamber 15 and the gas guide hole 37 are connected to each other, and a hole for connecting the end on the gas guide hole side of the groove 52 to the suction chamber 36 is formed in the rotary valve 35. The refrigerant gas in the crank chamber 15 can be introduced into the suction chamber 36 via the in-groove region of the groove 52 and the above-described hole.

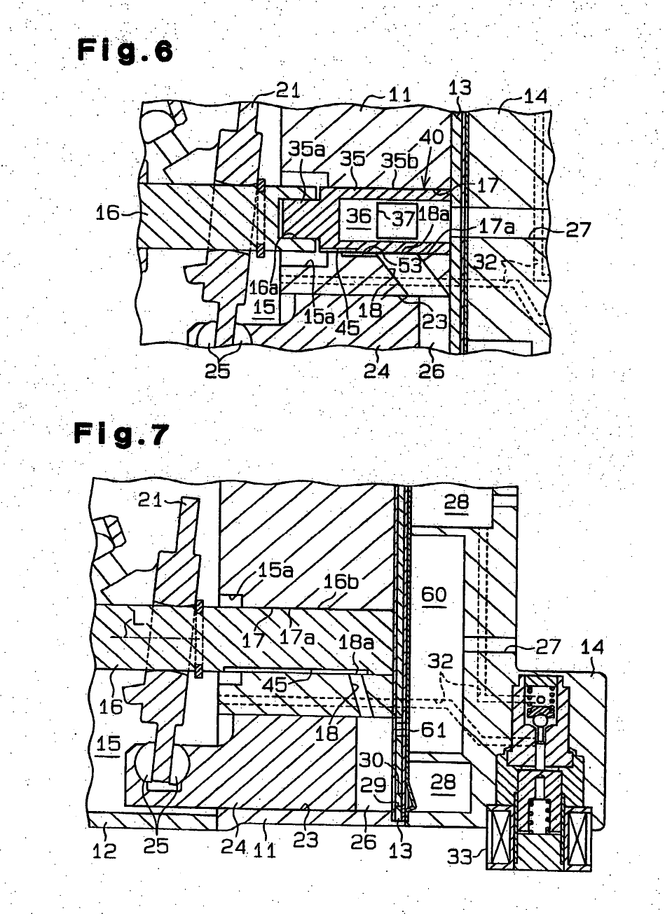

The groove 45 in the rotary valve 35 need not necessarily be extended rearward to a position at which the rear end thereof can face the opening 18a of the gas inlet passage 18. That is to say, the compressor may be configured, for example, as shown in FIG. 6. In this configuration, a groove 53 is provided in the inner circumferential surface 17a of the accommodation hole 17 so as to extend forward from the opening 18a of each of the gas inlet passages 18. Specifically, an in-groove region surrounded by the groove 53 and the outer circumferential surface 35b of the rotary valve 35 is connected to the gas inlet passage 18. The groove 45 in the rotary valve 35 is extended rearward to a position at which the rear end thereof is extended rearward at the front end of the groove 53. In this case; the in-groove region of the groove 45, the in-groove region of the groove 53, and the gas inlet passage 18 constitute a gas vent passage.

Although the suction valve mechanism having the rotary valve 35 is used in the above-described embodiment, the present invention is not limited to this configuration. For example, a reed valve mechanism may be used as the suction valve mechanism. In this case, the compressor is configured, for example, as shown in FIG. 7 Specifically, the valve plate assembly 13 is provided with a reed valve mechanism (suction valve mechanism) 61 for introducing the refrigerant gas in a suction chamber 60 formed on the rear housing side into the compression chamber 26. The reed valve mechanism 61 allows the introduction of refrigerant from the suction chamber 60 to the compression chamber 26, and also inhibits the discharge of refrigerant from the compression chamber 26 to the suction chamber 60.

In this configuration, the rotary valve 35 is not fixed to the rear end of the rotary shaft 16, and the rotary shaft 16 is extended rearward and the rear end portion thereof is slidably supported by the inner circumferential surface 17a of the accommodation hole 17 in a state of being accommodated in the accommodation hole 17. An outer circumferential surface 16b of the rear end portion of the rotary shaft 16 and the inner circumferential surface 17a of the accommodation hole 17 form a slide surface between the rotary shaft 16 and the accommodation hole 17 and a seal surface therebetween. In the outer circumferential surface 16b of the rear end portion of the rotary shaft 16, the groove 45 extending in the direction of the axis L is provided. The front end portion of the groove 45 is disposed in the central chamber 15a. The groove 45 extends rearward to a position at which the rear end thereof can face the opening 18a of the gas inlet passage 18.

This configuration as well can achieve the same advantages as those described in items (1) and (2) in the above-described embodiment.

In the above-described embodiments, a bleeding passage for connecting the crank chamber 15 and the communication path 27 (or the suction chamber 60) to each other may be provided in the housing (the cylinder block 11, the rear housing member 14, etch) of the compressor separately from the gas vent passage so that the refrigerant gas in the crank chamber 15 is also introduced to the outside of the crank chamber 15 by using this bleeding passage. In a case where the members constituting the housing are manufactured by casting, the bleeding passage can be formed in the casting process with relative case.

The present invention can be applied to an electrically-driven compressor having an electric motor as a drive source for driving thee rotary shaft 16.

Also, the present invention can be applied to a variable displacement compressor of a wobble type.

Further, the present invention can be applied to a compressor of a double-head piston type.

Still further, the present invention can be applied to a piston compressor of a wave cam type in which a wave cam is used as a cam body in place of the swash plate 21.

The present examples and embodiments are to be considered as illustrative and not restrictive and the invention is not to be limited to the details given herein, but may be modified within the scope and equivalence of the appended claims.

1. A piston type compressor that compresses refrigerant drawn to a compression chamber from a suction chamber, and discharges the refrigerant to a discharge chamber, the compressor comprising:
a crank chamber;
a rotary shaft;
a cylinder block having a cylinder bore and an accommodation hole;
a piston housed in the cylinder bore, wherein the piston defines the compression chamber in the cylinder bore;
a driving member accommodated in the crank chamber, wherein the driving member is coupled to the piston to convert rotation of the rotary shaft to reciprocation of the piston;
a cylindrical rotary valve that is coupled to the rotary shaft and rotatably accommodated in the accommodation hole, wherein an outer circumferential surface of the rotary valve slides along an inner circumferential surface of the accommodation hole, and wherein, in accordance with rotation of the rotary shaft, the rotary valve selectively opens and closes a gas suction passage between the suction chamber and the compression chamber; and
a gas vent passage for sending refrigerant gas from the crank chamber to the compression chamber, wherein at least a part of the gas vent passage is formed by a groove that is located in at least one of the inner circumferential surface of the accommodation hole and the outer circumferential surface of the rotary valve.

2. The compressor according to claim 1, wherein the gas vent passage includes a gas inlet passage that extends through the cylinder block to connect the accommodation hole with the compression chamber, and wherein, as the rotary shaft rotates, the groove intermittently connects the crank chamber with the gas inlet passage.

3. The compressor according to claim 2, wherein the compression chamber is one of a plurality of compression chambers, and the gas inlet passage is one of a plurality of gas inlet passages each extending from the corresponding compression chambers, and wherein the groove connects the crank chamber with the gas inlet passage that extends from a compression chamber the pressure of which is lower than the pressure of the crank chamber.

4. The compressor according to claim 3, wherein the rotary valve has a residual gas bypassing groove, wherein the residual gas bypassing groove introduces the refrigerant gas from a high pressure compression chamber to a low pressure compression chamber, wherein the high pressure compression chamber is one of the compression chambers in which a discharge stroke has been finished, and wherein the low pressure compression chamber is one of the compression chambers the pressure of which is lower than the pressure in the high pressure compression chamber.

5. The compressor according to claim 3, wherein the groove connects the crank chamber with the gas inlet passage that extends from a compression chamber in which a compression stroke is being started.

6. The compressor according to claim 3, wherein the groove connects the crank chamber with the gas inlet passage that extends from a compression chamber the pressure of which is lower than the pressure of the crank chamber without the suction chamber in between.

7. The compressor according to claim 2, wherein the groove is formed in the outer circumferential surface of the rotary valve.

8. The compressor according to claim 7, wherein the groove has an inlet that constantly communicates with the crank chamber and an outlet that intermittently communicates with the gas inlet passage as the rotary shaft rotates.

9. The compressor according to claim 7, wherein the gas suction passage includes the gas inlet passage and a gas guide hole formed in the rotary valve, wherein the gas guide hole has a first opening that constantly communicates with the suction chamber and a second opening that opens at the outer circumferential surface of the rotary valve, and wherein the second opening intermittently communicates with the gas inlet passage as the rotary shaft rotates.

10. The compressor according to claim 9, wherein the groove has a portion that is capable of communicating with the gas inlet passage, and wherein the portion is displaced from the second opening of the gas guide hole with respect to a rotation direction of the rotary valve.

11. The compressor according to claim 9, wherein the groove communicates with the gas inlet passage at timing that is different from timing at which the second opening of the guide passage communicates with the gas inlet passage.

12. The compressor according to claim 9, wherein the groove connects the crank chamber with the gas guide hole.

13. The compressor according to claim 7, wherein the groove is a first groove, wherein the gas vent passage further includes a second groove that is formed in the inner circumference surface of the accommodation hole to constantly communicate with the gas inlet passage, and wherein the first groove intermittently connects the crank chamber with the second groove as the rotary shaft rotates.

14. The compressor according to claim 1, wherein the driving member is supported to be inclined with respect to the rotary shaft, wherein an inclination angle of the driving member is changed according to the pressure in the crank chamber, and wherein, according to the inclination angle of the driving member, the stroke of the piston is altered to vary a displacement of the compressor.

15. A piston type compressor that compresses refrigerant drawn to a compression chamber from a suction chamber, and discharges the refrigerant to a discharge chamber, the compressor comprising;
a crank chamber;
a cylinder block having a cylinder bore and an accommodation hole;
a rotary shaft, wherein one end of the rotary shaft is supported by an inner circumferential surface of the accommodation hole such that the one end is rotatably received by the accommodation hole;
a piston housed in the cylinder bore, wherein the piston defines the compression chamber in the cylinder bore;
a driving member accommodated in the crank chamber, wherein the driving member is coupled to the piston to convert rotation of the rotary shaft to reciprocation of the piston; and
a gas vent passage for sending refrigerant gas from the crank chamber to the compression chamber, wherein at least a part of the gas vent passage is formed by a groove that is located in at least one of the inner circumferential surface of the accommodation hole and an outer circumferential surface of the rotary shaft.

16. The compressor according to claim 15, wherein the gas vent passage includes a gas inlet passage that extends through the cylinder block to connect the accommodation hole with the compression chamber, and wherein, as the rotary shaft rotates, the groove intermittently connects the crank chamber with the gas inlet passage.

17. The compressor according to claim 16, wherein the compression chamber is one of a plurality of compression chambers, and the gas inlet passage is one of a plurality of gas inlet passages each extending from the corresponding compression chambers, and wherein the groove connects the crank chamber with the gas inlet passage that extends from a compression chamber the pressure of which is lower than the pressure of the crank chamber.

18. The compressor according to claim 17, wherein the groove connects the crank chamber with the gas inlet passage that extends from a compression chamber in which a compression stroke is being started.

19. The compressor according to claim 17, wherein the groove connects the crank chamber with the gas inlet passage that extends from a compression chamberer the pressure of which is lower than the pressure of the crank chamber without the suction chamber in between.

20. The compressor according Lo claim 15, wherein the driving member is supported to be inclined with respect to the rotary shaft, wherein an inclination angle of the driving member is changed according to the pressure in the crank chamber, and wherein, according to the inclination angle of the driving member, the stroke of the piston is altered to vary a displacement of the compressor.
